(19) United States
(12) Patent Application Publication
(10) Pub. No.: US 2013/0297997 A1
(43) Pub. Date: Nov. 7, 2013

(54) COMPUTERIZED METHOD AND SOFTWARE PRODUCT FOR PRODUCING USER INTERACTIVE ELECTRONIC DOCUMENTS

(71) Applicant: Mark Philip Stanley, Lindfield (AU)

(72) Inventor: Mark Philip Stanley, Lindfield (AU)

(21) Appl. No.: 13/875,501

(22) Filed: May 2, 2013

(30) Foreign Application Priority Data
May 3, 2012 (AU) 2012901812

(51) Int. Cl. G06F 17/24

(52) U.S. Cl. CPC G06F 17/24
USPC 715/202

(57) ABSTRACT

A method of operating a computer system to convert non-interactive digital documents, such as electronic text and image files into interactive digital worksheets is provided. The method includes operating the computer system to prompt a user, such as a teacher for example, to identify a Base Document file accessible to the computer system. The computer system processes the Base Document to produce a corresponding dynamic document which allows the user to overlay data input fields overlaid. The user's overlays are recorded in a database along with meta-data that has been input by the user and which is associated with the overlaid data input fields. The meta-data that is recorded includes instructions determining the manner in which a further computational device, for example a student's PC, smartphone or tablet, interactively presents information of the base document to an end user, such as a student.

### CROSS REFERENCE TO RELATED APPLICATION

This application claims the benefit of and takes priority from Australian Patent Application No. 2012901812 filed on May 3, 2012, the contents of which are hereby incorporated by reference.

### TECHNICAL FIELD

The present invention relates to a computerized method and software product for generating user interactive documents. The invention also relates to a method and software product for using the interactive documents and in a preferred embodiment providing feedback to users of the document based on said use.

### BACKGROUND

The discussion of any prior art documents, techniques, methods or apparatus is not to be taken to constitute any admission or evidence that such prior art forms, or ever formed, part of the common general knowledge.

The educational movement in schools and Tertiary Education is to find better ways to engage students with interactive learning situations using multiple types of Internet based devices.

Publishers and owners of existing non-interactive digital content face enormous costs for content re-shaping and re-writing. These costs arise in effectively moving their existing ‘book and print based’ static digital content into interactive digital content that can extend and improve engagement with target audience across any internet connected device.

The enormity of the task in re-writing and reshaping existing digital content to create high levels of user interactivity with the content has slowed the development of new multimedia content. This in turn has frustrated many publishers who have large scale investments in existing printed and digital materials.

Currently there is no effective way for content contained in printed and multiple digital text file formats, and specific application data formats, to be directly converted into dynamic and interactive digital worksheets without base content conversion and much manually provided embedded coding. Indeed if there was a method, it would require the conversion of content from one proprietary format to another proprietary format. This extensive transposition and re-purposing of content would not offer any further or future options of extensibility and re-use.

It would be advantageous if there was a method for processing existing static training and/or teaching materials and transforming them to incorporate multimedia capability, thereby improving their educational ability.

### SUMMARY OF THE INVENTION

According to a first aspect of the present invention there is provided a method of operating a computer system including one or more computational devices to process a non user-interactive document (i.e. “the Base document”) to produce a user-interactive document, the method comprising the steps of:
prompting a user, such as a teacher for example, to identify a Base Document file accessible to the computer system;
operating the computer system to process the Base Document to thereby produce a corresponding dynamic document;
recording data input fields overlaid by the user on the dynamic document; and
recording meta-data input by the user associated with the overlaid data input fields in a database;
wherein the meta-data includes instructions determining the manner in which a further computational device, for example a student's PC, smartphone or tablet, interactively presents information of the base document to an end user, such as a student.

The method may also include a step of confirming to the user, e.g. the teacher, that the data input fields have been correctly recorded for purposes of correction if necessary.

The step of recording the meta-data may include making one or more XML definitions, i.e. “schemas” corresponding to each base document.

For example, depending on which of the one or more XML schemas the end user, e.g. a student, is provided with, the interactivity over the associated base document will vary.

Preferably the step of recording the data input fields includes recording information associated with the data input fields. For example, the step may include recording correct answers to questions associated with the fields.

Furthermore, the step of recording the data input fields may include recording information such as interactivity guidance properties associated with the fields.

Preferably the Base document comprises a PDF (i.e. Adobe Portable Document File format) file although it is possible that the Base document could comprise a graphic file such as a JPEG, SVG, BMP, TIFF, GIF or other format file.

In a preferred embodiment of the method the dynamic document comprises an Adobe SWF format file, i.e. an SWF file in a format specified by Adobe Systems Incorporated.).

In one embodiment the step of operating the computer system to process the Base Document includes transferring the dynamic document from a server to a personal computational device along with mapping code for execution on the personal computational device wherein the mapping code facilitates the user overlaying the data input fields.

In the preferred embodiment the step of making a record of the data input fields includes recording coordinates of the data input fields relative to the dynamic document.

For example, the dynamic document may comprise the SWF file and the mapping code may be included with the SWF file in a Flash container for execution by a plug in of a browser of the personal computational device.

Preferably the method also includes a step of converting the Base document into a number of graphic files.

The mapping code may comprise an application specifically designed for execution on a personal computational device running a particular operating system. For example, the mapping code may comprise an App for execution on an Android mobile phone or tablet or on an iPad or iPhone or the like.

The method preferably includes a step of serving the dynamic document, including said overlaid data entry fields, to remote computational devices of further users. For example, where the content of the dynamic document comprises educational and/or training information the further users may comprise students.

Ideally the method includes processing dynamic documents returned from the further users, e.g. the students, along answers and other inputs entered by the further users.

The method may also include storing the answers for later processing to generate statistics associated with the returned answers and other inputs for each further user. For example, the statistics may comprise a score of correct answers.

In a preferred embodiment of the invention the method includes assessing the returned answers and other inputs against the correct answers previously recorded during production of the interactive document to thereby provide auto-marking.

According to a further aspect of the present invention there is provided a computer system programmed with a computer software product for performing the previously described invention.

According to another aspect of the invention there is provided an optical or magnetic media bearing machine readable tangible instructions for execution by one or more processors of a computational device for performance of the previously described method.

According to a further aspect of the present invention there is provided a server capable of establishing a data connection with at least one remote computational device, wherein the server includes:
a means to serve a website prompting a user of said computational device to upload a Base document;
a means to process the Base document to produce a dynamic document corresponding thereto; and
a means to transmit the dynamic document along with mapping code to the remote computational device
wherein the server is arranged to produce mapping code which includes instructions for the remote computational device to facilitate user definition of data entry fields overlaid on the dynamic document.

Preferably the server is further arranged to serve the dynamic document including said overlaid data entry fields to a remote computational devices of further users. For example, where the content of the dynamic document comprises educational and/or training information the further users may comprise students.

Preferably the server is further arranged to process dynamic documents returned from the further users, e.g. the students, along with answers and other inputs entered by the further users.

In a preferred embodiment of the invention the server includes a means to store the answers and other inputs returned from the further users.

The server may be further arranged to store the answers for later processing to generate statistics associated with the returned answers and other inputs for each further user. For example, the statistics may comprise a score of correct answers.

The server may also include a means to assess the returned answers and other inputs against the correct answers previously recorded during production of the interactive document to thereby provide an auto-marking functionality.

### BRIEF DESCRIPTION OF THE DRAWINGS

The Detailed Description is not to be regarded as limiting the scope of the preceding Summary of the Invention in any way. The Detailed Description will make reference to a number of drawings as follows:

FIG. 1 is a block diagram illustrating a computer system for carrying out a method for interactive document creation according to a preferred embodiment of the present invention.

FIG. 2 comprises a first portion of a flowchart of the steps of the method.

FIG. 3 comprises a second portion of the flowchart of the steps of the method.

FIGS. 4 and 5 are screen shots of a document prior to its conversion to a PDF format base document.

FIGS. 6 to 8 are screen shots of display screens presented to a user during performance of the method for entry of meta-data about the base document.

FIG. 9 is a screen shot of a display screen presented to the user during performance of the method for users to select a number of operation tabs along the top border of the screen.

FIG. 10 shows a screen of a dynamic document during user overlaying of a data entry field over the underlying base document.

FIG. 11 displays a screen for a user to specify logic associated with an overlaid field.

FIG. 12 depicts a screen for users to test that the mapping and associated logic has been correctly recorded.

FIG. 13 is a flowchart of a method for a user to interact with the interactive document with a tablet computational device such as an iPad according to a preferred embodiment of the present invention.

FIGS. 14 and 15 are screen shots produced during the method referred to in FIG. 13.

Preferred features, embodiments and variations of the invention may be discerned from the following Detailed Description which provides sufficient information for those skilled in the art to perform the invention.

### DETAILED DESCRIPTION OF PREFERRED EMBODIMENTS

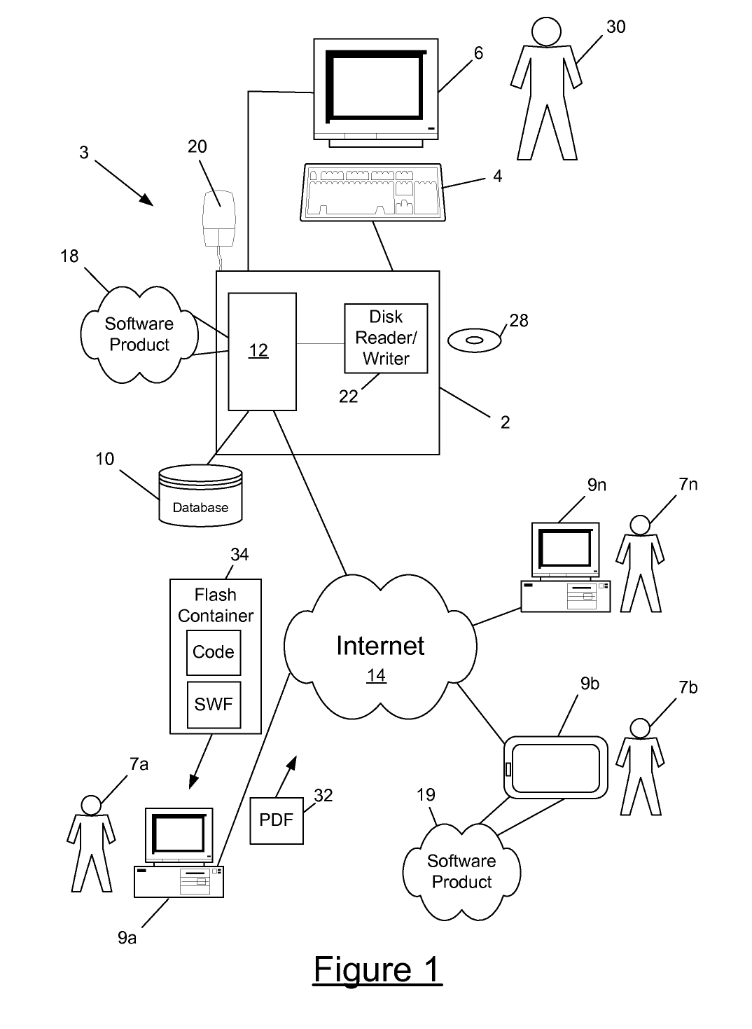

Referring now to FIG. 1, there is depicted a block diagram illustrating the entities involved in the performance of an electronic document transformation method according to a preferred embodiment of the present invention.

A method according to a preferred embodiment of the present invention will be described in the context of the preparation of interactive educational documents. However, the invention is not limited to this particular application and it may certainly be used to produce interactive documents in areas other than education and training.

Computer installation 3 includes a computer 2 which, in turn, includes a controller 12 having a processor, RAM, ROM and various secondary data storage devices such as a hard disk drive.

The controller 12 executes the software product 18 stored in data storage that contains instructions for implementing the interactive document creation method. The software product 18 is typically provided on an optical or magnetically readable medium such as a CD-ROM or floppy diskette 28, which can be read by controller 12 via disk reader 22. Alternatively, software product 18 might be provided in a ROM or other electronic circuit as firmware or downloaded from a remote location over a computer network 14 such as the Internet. The software product 18 includes instructions for system 3 to implement the interactive document creation method that will be explained in detail below.

By means of conventional interfacing circuitry of computer 2, the controller 12 receives commands entered by an administrator 30 from input devices such as keyboard 4 and mouse 20, and displays information on display 6. Controller 12 communicates with a number of peripheral devices including the disk writer 22 and a removable disk 28.

Computer installation 3 may be standalone however more typically it is configured as a computer server in communication with internet 14. Accordingly, it is able to establish data communications with a number of remove client devices such as remote personal computers 9n and 9a and remote tablet device, e.g. iPad 9b.

During its operation the computer server 3 executes instructions comprising software product 18 that are stored as tangible, machine executable instructions on a magnetic disk or optical disk 28 accessible to the server's one or more processors on controller board 12. The computer software 18 contains instructions for the server to implement a method according to a preferred embodiment of the present invention that will be described shortly.

In a preferred embodiment of the invention, in use the server 3 communicates with one or more personal computers 9a, . . . ,9n such as computer 9a to thereby provide a PC/WEB based system.

The PC/WEB based version of the software has all administration and creation tools included. The application runs on the PC 9a as a WEB application directly from a live connection to the Internet. The application executes in any PC/MAC based Internet Browser running on PC 9a in which Adobe Flash has a plug in component.

In order to do so the server downloads a Flash container 34 which, as will be explained contains code for execution by the Flash plug in component on PC 9a's browser. The container 34 also contains a SWF file which the code operates on.

The PC/WEB based version can also execute in User mode, emulating the functionality supplied in the User iPad and Android tablet applications by means of a dedicated application or “App” 19 running on the tablet 9b.

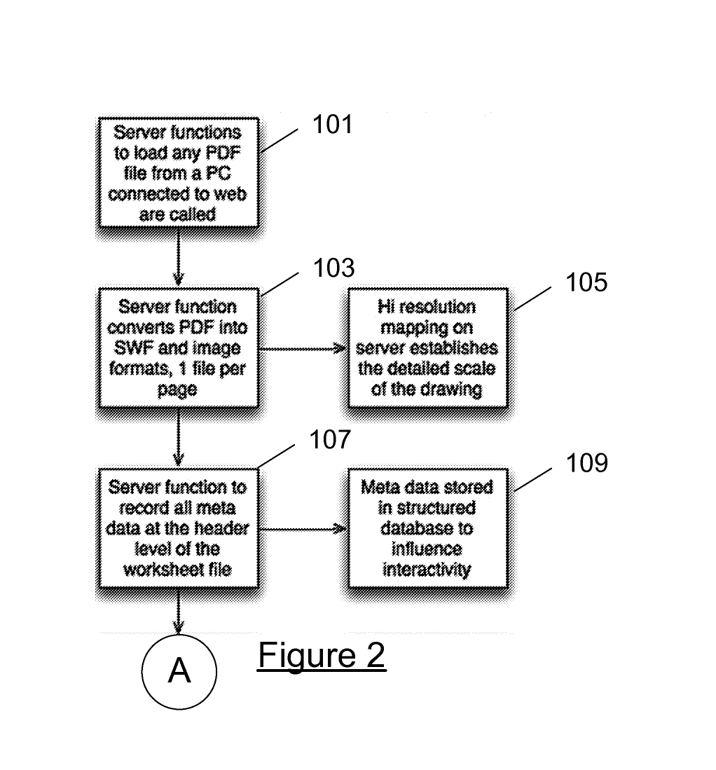

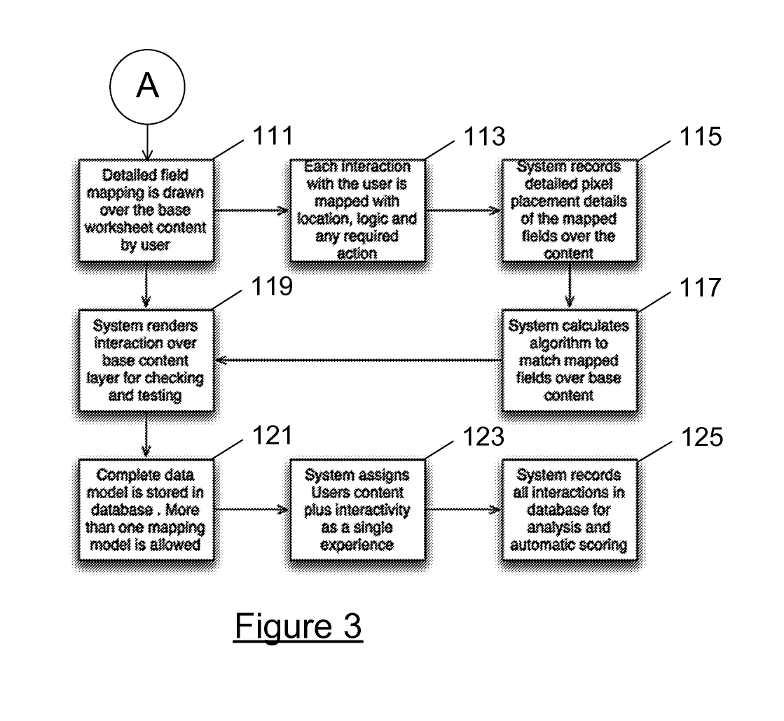

FIG. 2 is a flowchart of the computer implemented method according to a preferred embodiment of the present invention for server 3 to communicate with a remove user device, such as to create an interactive document.

It will be realized that as the computer server 3 of FIG. 1 implements the method it is effectively arranged to comprise a number of functional modules which carry out various processes. In a preferred embodiment of the invention these functional modules include:
a. a website serving module which is arranged to serve a website to a remote computational device to prompt a remote user to upload a base document, such as a non-interactive PDF document for example.
b. a base document processing module which is arranged to produce a dynamic document module corresponding to the base document.
c. a mapping code generation module which is arranged to produce mapping code that includes instructions for the remote computational device to facilitate user definition of data entry fields overlaid o the dynamic document; and
d. a dynamic document transmission module, which is arranged to transmit the dynamic document, along with the mapping code to the remote computational device.

Of course, the above modules could be manufactured as separate hardware modules which are then interconnected. However it is more practical to program a suitable web server (or web servers).

PC/WEB based computation processes.

At box 101 of FIG. 2 User 7a, by means of PC 9a, enters a web site which is served by server 3 across Internet 14 and uploads a PDF file 32 from PC 9a which is connected to the Internet 14.

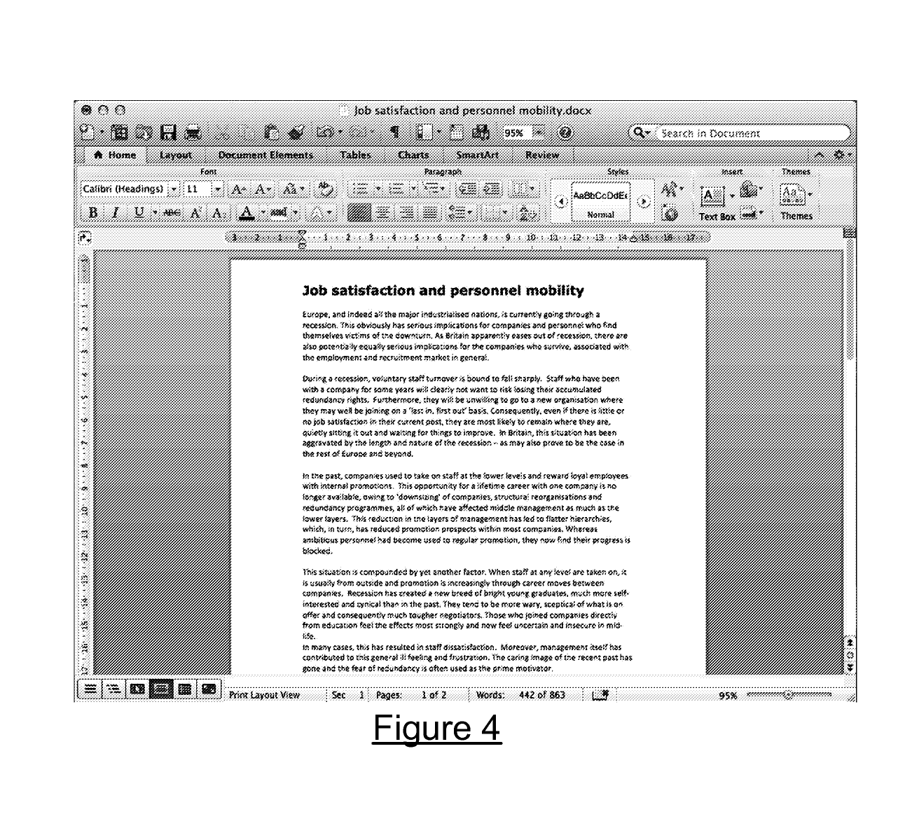

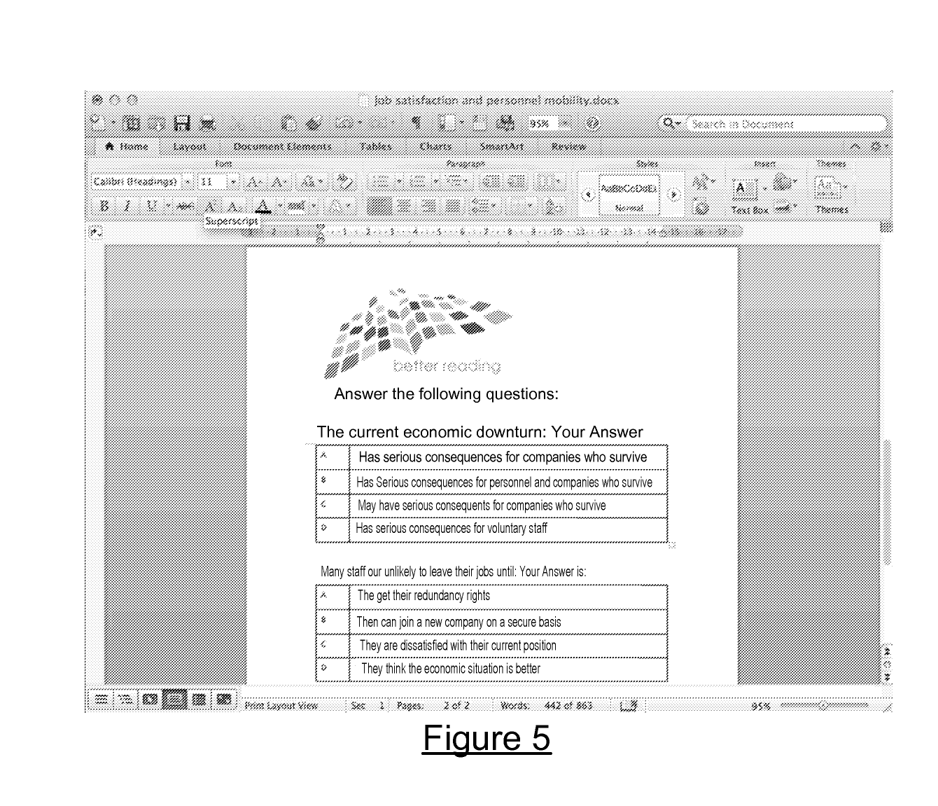

Server 3 prompts for and receives the binary PDF file across http protocols, streaming the User's original PDF file to a directory location on or accessible to server 3. The file must be a PDF file prior to load. FIGS. 4 and 5 show a MS-Word document prior to it being processed to generate a suitable PDF format document. Virtually any other document or graphic format may also be processed to generate a PDF document if required.

At boxes 103 and 105, a Server function of software product 18 converts the loaded PDF file to a to SWF format.

SWF files are used by the Adobe Flash software product. The SWF file format specification is maintained by Adobe Systems Inc. The SWF file format delivers vector graphics, text, video, and sound over the Internet and is supported by Adobe® Flash® Player software.

Dimensions of the loaded page are calculated in pixels from the top left to the bottom right of the converted file. The SWF format directly represents the exact dimensions of the loaded PDF.

The worksheet is assigned reference data ID's to allow all subsequent information stored to be relationally referenced.

In parallel to SWF conversion and loading, the original, i.e. “base” PDF file 32 that has been loaded is scanned for the number of pages. For each PDF page, a high resolution JPEG or SVG file is created. These images are stored in a file system that directly references the original PDF and the SWF file on which the subsequent processes rely. JPEG or SVG file resolutions are created and stored at 300 dpi maintaining the integrity of the base PDF base document.

At boxes 107 and 109 the database 10 is updated with all related file information linked to the base sheet details that were previously recorded. Database library records, created for each PDF base document are also uploaded.

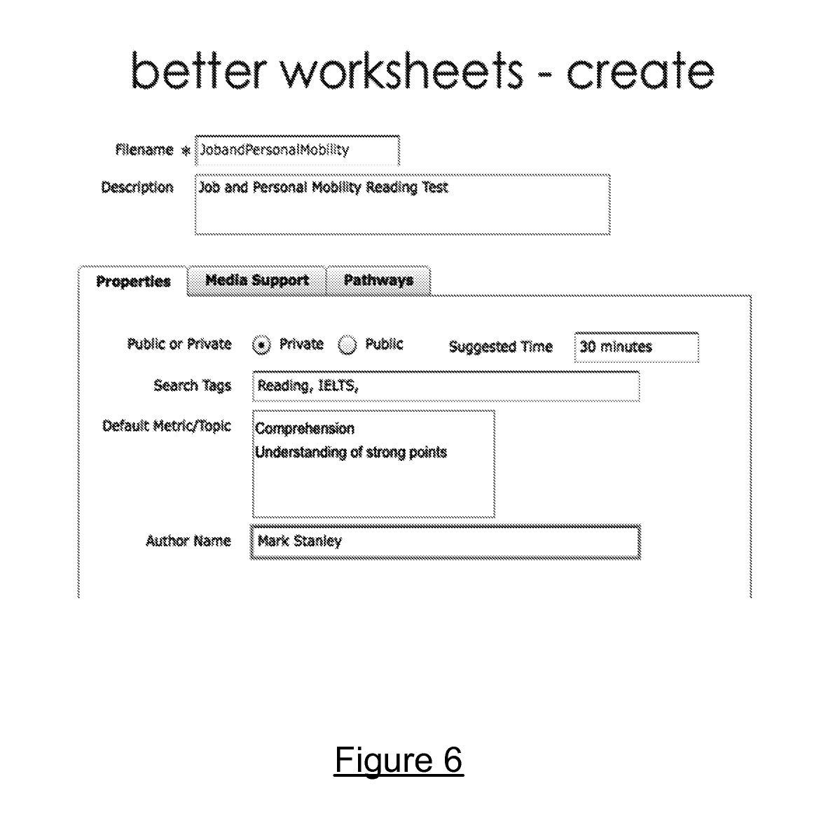

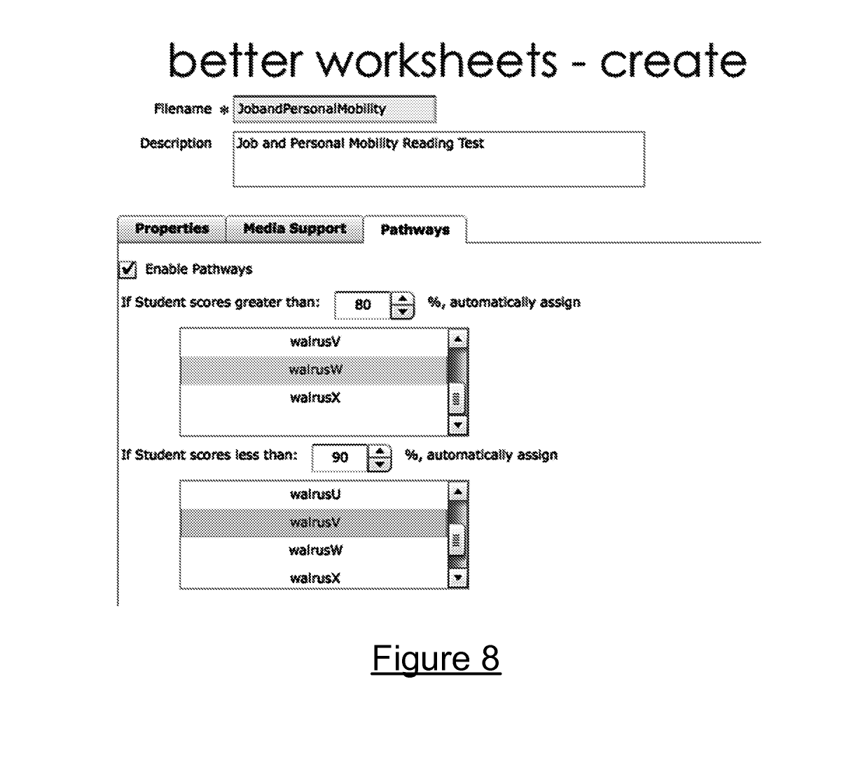

Worksheet properties are inserted into the database as illustrated in the screen shots of FIGS. 6 to 8 thereby allowing the User to define search and sorting criteria, learning pathway links to other sheets, activated at run time and external web based resources such as Video and Audio URL address links.

As previously mentioned, the SWF file 31 and mapping code 33 are downloaded in a Flash container 34 to the PC 9a for processing by the Flash plugin running in the browser application on that PC.

With reference to Boxes 111-117 of FIG. 2, the mapping code 3 allows the User to ‘map’ the level of interactivity required on the form. This includes the system matching mapped fields over base content as will be described in more detail shortly. No changes are made to the underlying PDF base document or JPG/SVG representations of the base PDF source, ensuring copyright materials are not impacted or compromised in the addition of the interactive layers.

Mapping the Interactivity of the form.

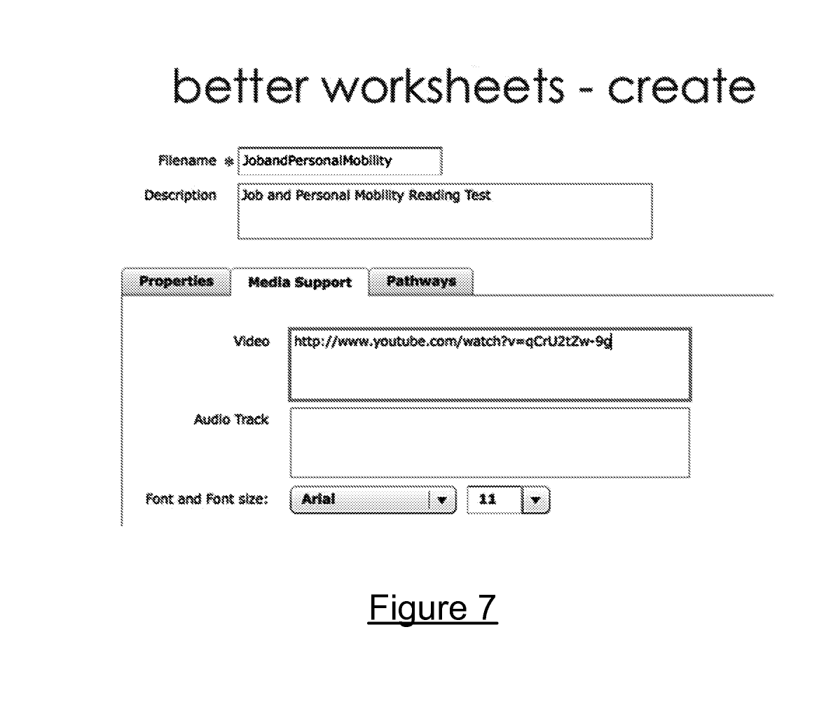

With reference to FIG. 7, the User opens an Administration function of the Interactive Form mapping tool and is presented with a SWF representation of the PDF base document. This SWF copy is a direct representation of the PDF base document, pixel perfect in terms of resolution and relative size and position of all elements on the original PDF document. The System, i.e. the PC 9a executing the mapping code in communication with the server executing the server software and in communication with the database is able to ascertain the exact size of the original file.

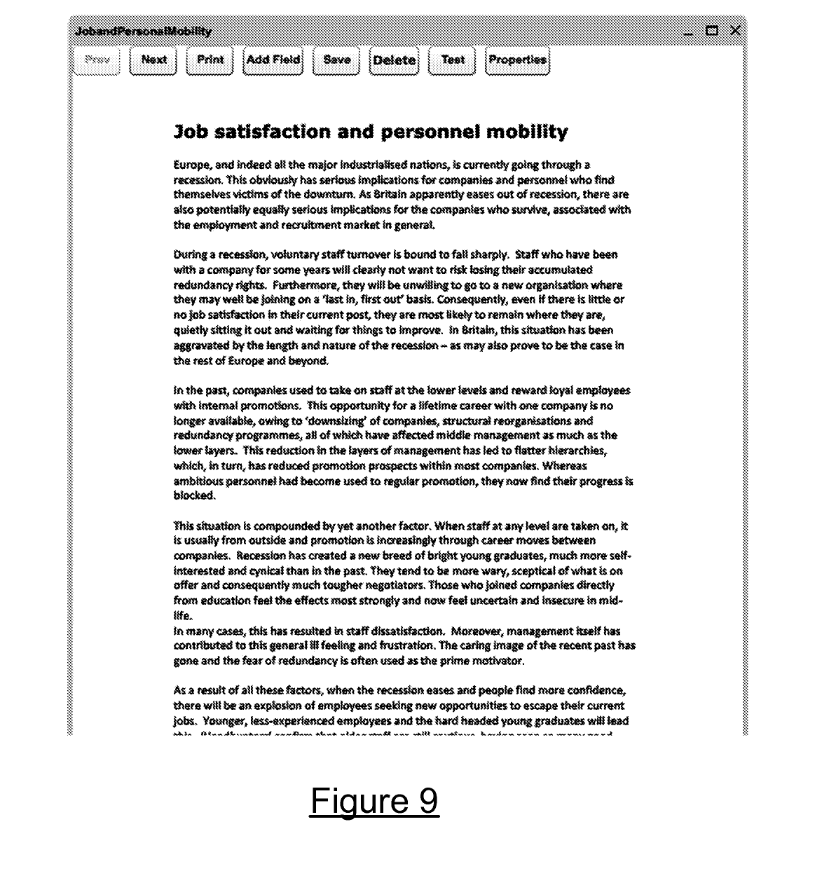

The User may then select the Add Field tab shown at the top of FIG. 9. The User is then able to create a data entry container or interactive entry point over the top of existing spaces or field positions designed in the original PDF base document.

A data entry container will be understood to be any kind of form, radio button, selection list or any other type of means for a user to enter data into a software application.

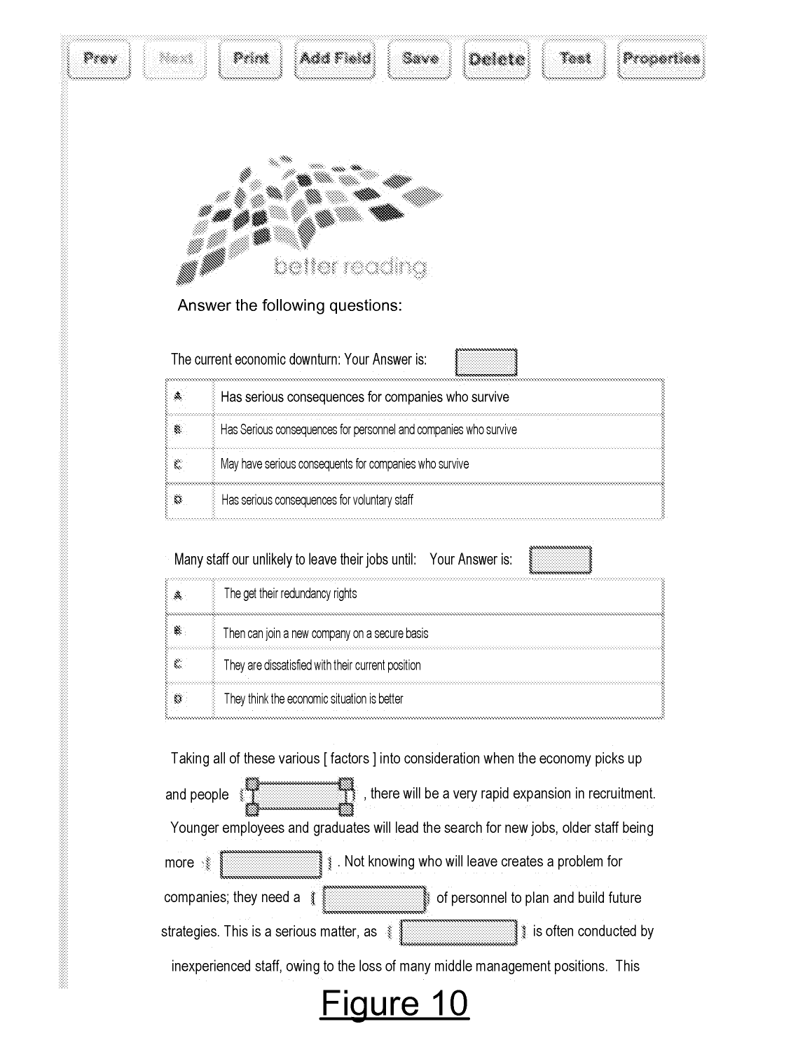

The User is then presented with drag-able and resizable overlay shapes as shown in FIG. 10. The User selects a shape and draws an overlay entry box over the underlying space/shape as provisioned on the original PDF base document, shown on screen in a SWF representation. The Interactive Form mapping tool includes instructions to do this.

The mapping code of the Interactive Form mapping tool includes instructions to calculate the relative position and size of the User defined overlay shape as pixel point X, Y co-ordinates from the top left corner of the SWF file. User screen resolution and current screen scaled size is catered for in the assignment of the X. Y co-ordinates.

System records all overlay mapping fields in a Worksheet Detailed Mapping XML file, linked directly to the SWF file, linked to the underlying PDF base document.

The Worksheet Detailed Mapping XML file is stored in a database 10 (FIG. 1) on creation of the first User defined field. The XML file is directly referenced to the file master record and Worksheet properties table that was previously created.

Detailed mapping of underlying properties for each overlay interaction.

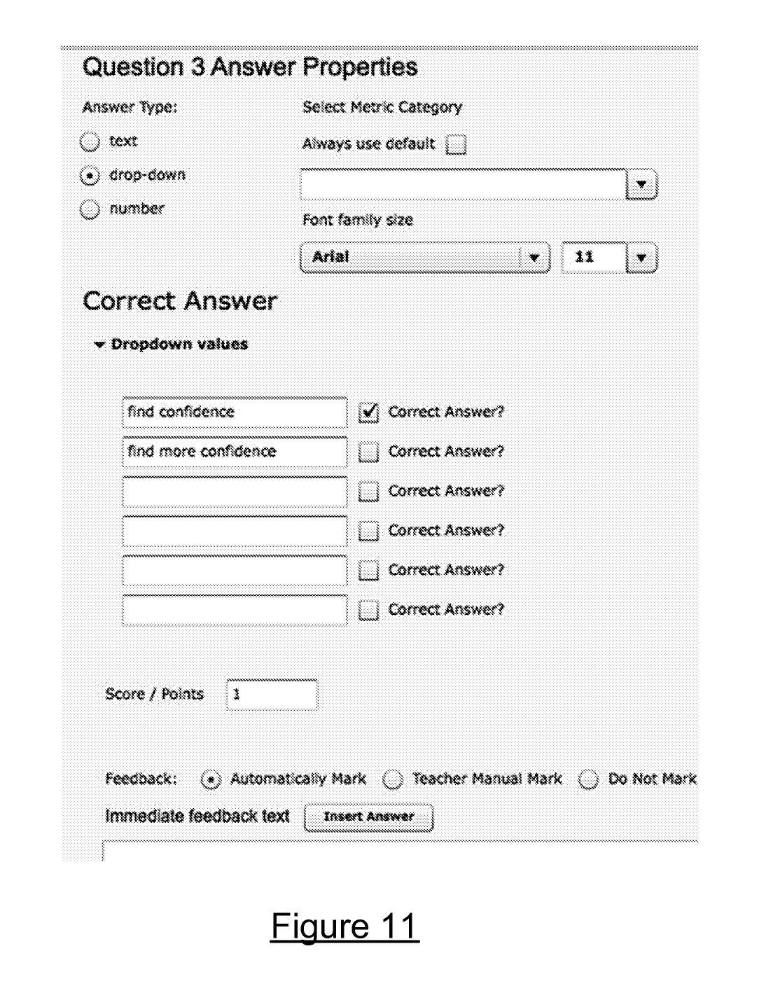

For each overlay shape that is defined by the User, User can add additional Meta Data to describe the behavior of the shape when the form is deployed to end user devices for completion. The interactivity logic and requirement is stored per overlay shape (field) as illustrated in the screenshot in FIG. 11. The main types of data that are stored are:

Meta data that describes the attributes and behaviour of the overlay shape at the point of end user execution is added as properties for each overlay shape. Attributes such as, Data Type (Number, Text, True/False etc), Descriptors, Help when answering, Correct Answer, WWW links to be presented to end user when interacting with the form, metric aggregator, marks allocated to a correct answer, relative score weights applied to a correct answer, video and audio Internet URL address links. A visual User interface drives this mapping definition process.

Scoring behavior—System can automatically score the worksheet based on a comparison between the recorded correct answer and the End user entered answer. Manual marking interventions can be defined also.

Links to external resources can be defined so that in form execution mode, Internet based supporting materials can be injected into the user experience.

Each interaction mapped is stored in the Worksheet Detailed Mapping XML definition file, in the database. The Worksheet Detailed Mapping XML definition file stores all relative positioning co-ordinates along with the attributes defined for each overlay field.

Any number of XML ‘schemas’ per form to be created by the user can be defined. The user may, for example, define a number field into which a number is entered and validated. Subsequently that definition can be changed if desired. For example a number field may be changed to a text field, associated help text may be created or a link to video support and explanation. Extra web links might also be added and the formed saved as unique to a particular user and their class of students.

Not only are the obvious data elements of a form or worksheet mapped, any part of the form can be mapped with an interactive ‘launch point’ or ‘hot spot’ that triggers additional interactivity defined in the XML file that is being overlaid.

Learning pathways can be interactively defined, allowing teachers to chain worksheets together subject to marking criteria and scores being achieved on completion or submission of the worksheet. Upper level students can be directed to do higher level work subject to achieving a mark of, say, 90%. Other students can be directed down.

When the ‘form’ runs, the appropriate or desired XML interactivity is delivered. The students are given the XML map the teacher wants them to use over the base document which has not changed.

The collaborative power of this allows teachers to share base documents map worksheets in various and multiple languages which is particularly advantageous for ESL students for example, map to differing levels of interactivity and share mapping files that apply to the one base document.

It will therefore be realized that the processes that are triggered when an end user, such as a student, interacts with the document can be defined over the form any way the teacher likes. Furthermore, the definition of the processes can be achieved by the teacher without any programatic interjection or knowledge of code or interference with existing data definitions. Base definitions can be picked up and modified, changed, saved or saved AS to be applied in differing situations by differing teachers/users.

All answers that are stored per sheet are linked to the XML definition layer in which they were submitted—allowing for history and continual change of the worksheets to be ongoing. Not only is the definition layer abstracted from the data captured from the user, it is also perfectly aligned to the mapping XML file. All data is of course stored in a database (automatically) with the corresponding XML map file to guide its future use and analysis.

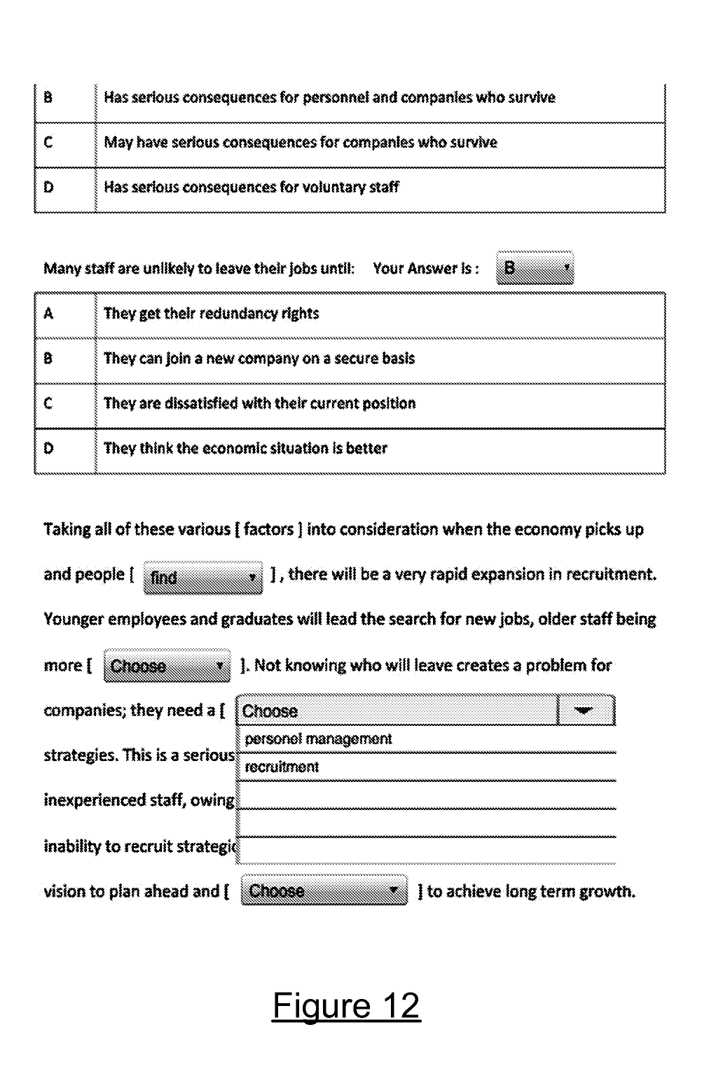

Referring again to the flowchart of FIG. 2, at Box 119 the User is presented with a test screen, as shown in FIG. 12 for the User to test the mapping and Interactivity.

At this point the following processes have been completed:
a. Base PDF file is stored on the server—linked to an end User account and User permission profile.
b. SWF file and JPEG files are created, linked to the base PDF file.

Critical file sizing and dimension data is extracted and stored in the Worksheet Properties table in the database.
c. Worksheet Properties table updated with Worksheets details, X,Y pixel co-ordinates and dimensions.
d. Worksheet Detailed Mapping XML definition file created, linked to the

Worksheet properties table stored in the database. All Meta data corresponding to each overlay shape defined is stored and linked in the Worksheet Detailed Mapping XML.

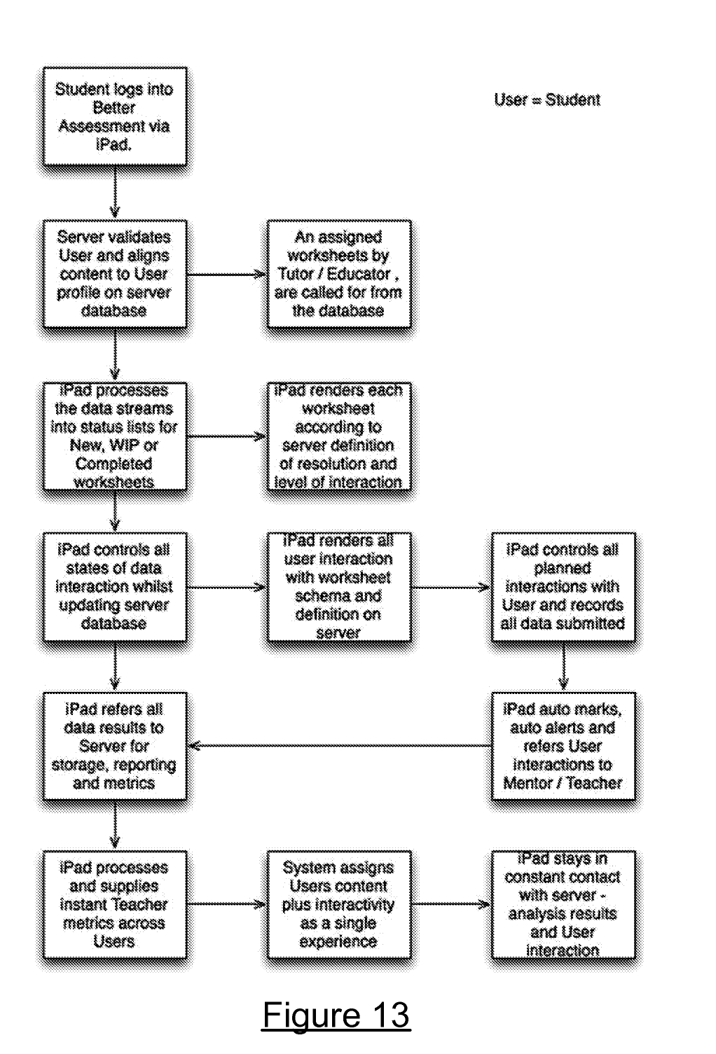

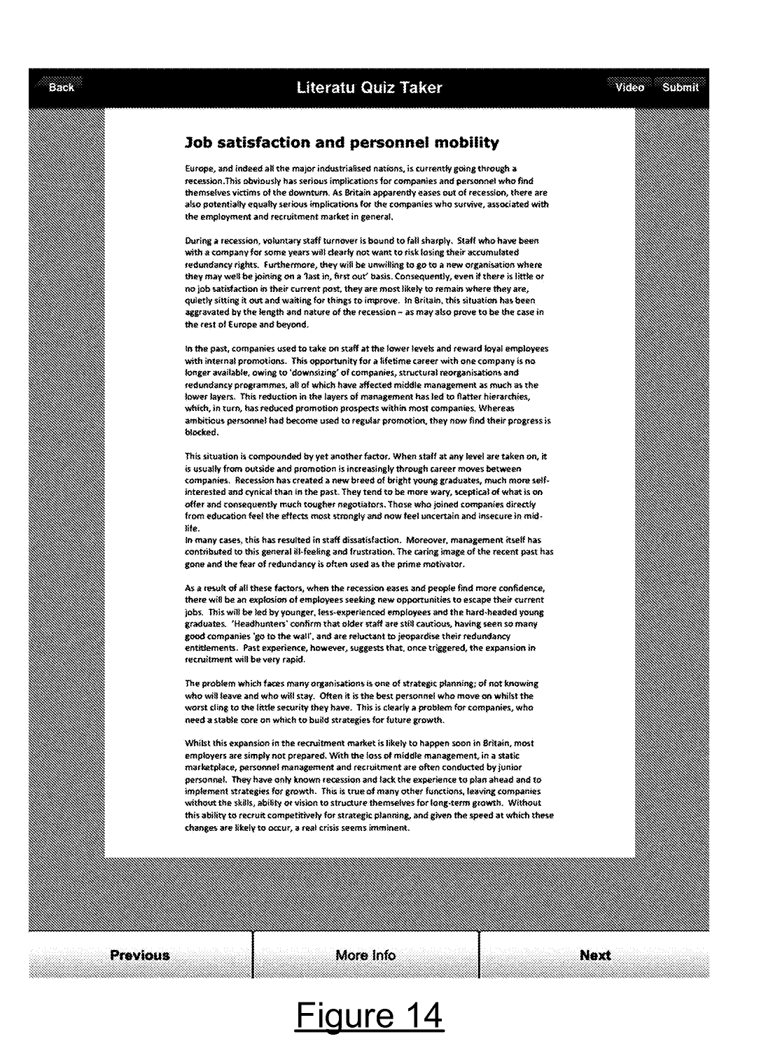

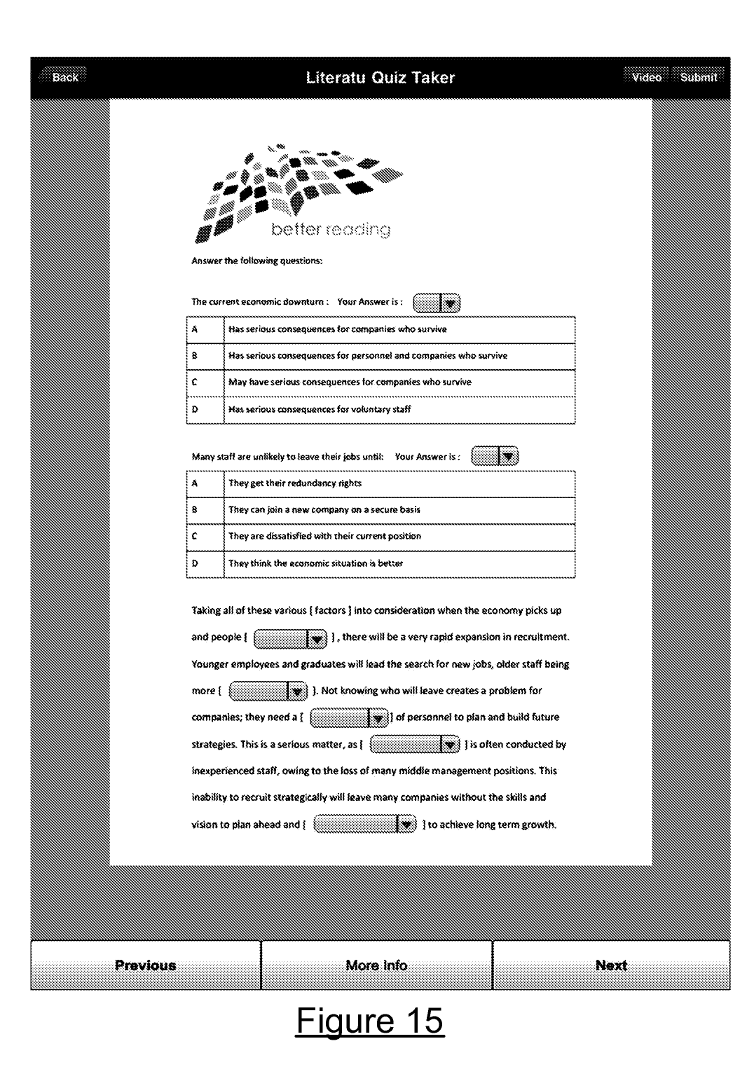

Once the mapping has been completed, the system is ready to deploy the interactive worksheet to End-users for completion. The method by which this is done is set out in the flowchart of FIG. 13. A similar method is also performed when a PC is used by a student to make use of one of the interactive documents created by the previously described method.

Deployment Computations.

User Roles are defined in the system, allowing end Users at differing levels to have access to various elements of system functionality.

Teachers can load and map the base worksheets, add logic, collaboratively author the work sheets (key feature) and share the worksheet amongst other teachers in the same community.

PC/WEB computational conditions.

PC will activate a browser session that will connect through to the Internet. The controlling and validating web site will validate the User by way of secure login, securing the profile role of the User from the database. The User will be defined as a Teacher Role, a Student Role or an Administration role.

Student Role will be granted access to complete worksheets that have been allocated to the Student by a Teacher.

Student opens a session; Database is queried; user session is identified as being on a PC browser. PC Browser launches the SWF representation of the PDF Source worksheet. The Worksheet Detailed Mapping XML service opens and reads the Worksheet Detailed Mapping XML parameters from the database. The Form Rendering service then loads the Worksheet Detailed Mapping XML definition layer from the database. This is placed in the cache of the browser as an immediate point of reference to underlying data attributes and extended definitions such as Video links.

Calculations are made on the PC to render the exact overlay definition, contained in the Worksheet Detailed Mapping XML, over the loaded SWF representation. Screen sizing and resolution of the display used are calculated with reference to proportional dimensions of the base PDF Source worksheet dimension. Scaling of the base SWF file is made along with a corresponding scaling of the XML definition co-ordinates, mapping the interactive layers over the correct positioning of the SWF file.

As screen sizes are expanded and minimized by the User, the relative mapping co-ordinates contained in the Worksheet Detailed Mapping XML definition for each field that needs completion, are scaled to correctly align to the base SWF file presentation. This allows the User to re-size the window in which the application is running.

The Student completes the worksheet by answering all elements or completing all presented answer/interactive dialogue boxes. Student can request for more information per field if there is additional information available in the Detailed Mapping XML. System will interact with the XML definition layer per mapped field and return any extended reference information to Student in a system dialogue. Student can launch any associated links and materials that are contained in the XML definition layer of the worksheet.

On completion of worksheet, Student can submit the worksheet. On Submit, the worksheet is automatically marked and assessed by the server based marking submission services. Student answers are compared to correct answers, if mapped in the Detailed Mapping XML definition layer for the question. An overall score is calculated per worksheet. The Student answers are stored in the Detailed Marking XML file linked to the Student worksheet session. These answers are available as a permanent record for the Student.

If at the worksheet properties level, leaning pathways have been defined in the worksheet properties XML, Students will be guided to complete more worksheets at a higher or lower level of sophistication, depending on their results. These Learning Pathways are be referenced in the worksheet properties table.

System updates the worksheet marking tables in the database, metric values are stored and summary statistics are built from the data. These results are made available to the Teachers and Students as current and historic snapshots.

If any questions are tagged as Manually Marked, the system will route the worksheet to the assigned Teacher for manual marking on line. Teachers have a manual-marking interface to any Student worksheets that require manual marking. Once completed, the worksheet will be flagged as complete.

If the Teacher has aligned and mapped a series of Metric classifications to each question or date element in the worksheet, Teacher can review overall Student performance with reference to these metrics.

iPad Computational Conditions

With reference to FIG. 1, User 7b will connect to the Better Writing iPad application 19 running on an iPad device 9b connected to the Internet. The controlling and validating web site will validate the User by way of secure login, securing the profile role of the User from the database. The User will be defined as a Teacher Role or a Student Role.

The iPad will execute the same processes as the PC Web version with the following differences.

Screen size for the iPad is optimized at 1024×768. All scaling and corresponding overlay mapping is optimized at this resolution.

iPad application renders JPEG/SVG files to the User, over which the application maps the interactive defined fields as contained in the Detailed Mapping XML retrieved from the database. The base PDF, on which the content is based, is represented as high resolution JPEG/SVG files.

Any work partially completed on the iPad can be completed on the PC WEB browser interface.

It will be realized that embodiments of the presently described invention provide significant improvements over interactive form creation methods known in the past. For example, Adobe Systems Inc. provides a system for making PDF documents with data entry forms. However the relationship between the form and its data fields is 1-1. One ‘name’ field is defined with 1 ‘name box’ into which the ‘name’ is entered. Some basic validation is sometimes done, no data connections or storage is offered. If a user wishes to change something for themselves then they have to create a new form and map 1-1 on that. If the user wants to store the data then a programmer will need to become involved. Furthermore, the data would have to be stored as a 1-1 relationship with the mapping format.

The detailed description contained herein is represented partly in terms of processes and symbolic representations of operations by a conventional computer and/or wired or wireless network. The processes and operations performed by the computer include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure.

A “data packet” is type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purpose of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated.

It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user that interacts with the computer.

Hardware

It should be understood that the programs, processes, methods, etc. described herein are not related or limited to any particular computer or apparatus, nor are they related or limited to any particular communication architecture, other than as described. Rather, various types of general purpose machines, sensors, transmitters, receivers, transceivers, and network physical layers may be used with any program modules and any other aspects of the invention constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read-only memory.

Program

In the preferred embodiment where any steps of the present invention are embodied in machine-executable instructions, the instructions can be used to cause a general-purpose or special-purpose processor which is programmed with the instructions to perform the steps of the present invention.

Alternatively, as previously alluded to, the steps of the present invention might be performed by specific hardware components or “modules” that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

Product

Embodiments of the present invention may be composed of hardware and computer program products which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the software portion of the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

Web Design

Any web site aspects/implementations of the system include conventional web site development considerations known to experienced web site developers. Such considerations include content, content clearing, presentation of content, architecture, database linking, external web site linking, number of pages, overall size and storage requirements, maintainability, access speed, use of graphics, choice of metatags to facilitate hits, privacy considerations, and disclaimers.

Other Implementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive. It is therefore not intended that the invention be limited except as indicated by the appended claims.

It will be realized that many variations to the invention are possible other than the specific preferred example provided herein.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

I claim:

1. A method of operating a computer system including one or more computational devices to process a non user-interactive document (i.e. “the Base document”) to produce a user-interactive document, the method comprising the steps of:
prompting a user, such as a teacher for example, to identify a Base Document file accessible to the computer system;
operating the computer system to process the Base Document to thereby produce a corresponding dynamic document;
recording data input fields overlaid by the user on the dynamic document; and
recording meta-data input by the user associated with the overlaid data input fields in a database;
wherein the meta-data includes instructions determining the manner in which a further computational device, for example a student's PC, smartphone or tablet, interactively presents information of the base document to an end user, such as a student.

2. A method according to claim 1, wherein the Base document comprises a non-interactive text file or a graphic file.

3. A method according to claim 1, wherein the dynamic document comprises an Adobe SWF format file.

4. A method according to claim 1, including serving the dynamic document, including said overlaid data entry fields, to remote computational devices of further users.

5. A method according to claim 4, including processing dynamic documents returned from the further users with answers and other inputs entered by the further users.

6. A method according to claim 5, including storing the answers for later processing to generate statistics associated with the returned answers and other inputs for each further user.

7. A method according to claim 6, including assessing the returned answers and other inputs against the correct answers previously recorded during production of the interactive document to thereby provide auto-marking.

8. A computer system programmed with a computer software product for performing the method of claim 1.

9. A computer software product comprising a machine readable media bearing tangible instructions for execution by one or more processors of a computational device for performance of a method according to claim 1.

10. A computer server capable of establishing a data connection with at least one remote computational device, wherein the server includes:
a website serving module arranged to serve a website to a remote computational device to prompt a remote user to upload a base document;
a base document processing module arranged to produce a dynamic document module corresponding to the base document;
a mapping code generation module arranged to produce mapping code that includes instructions for the remote computational device to facilitate user definition of data entry fields overlaid on the dynamic document; and
a dynamic document transmission module, arranged to transmit the dynamic document and with the mapping code to the remote computational device.
